(19) United States
(12) Patent Application Publication
(10) Pub. No.: US 2004/0175197 A1
(43) Pub. Date: Sep. 9, 2004

(54) Image forming apparatus and method of controlling developing unit thereof

(75) Inventor: Myung-ho Kyung, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/799,693

(22) Filed: Mar. 15, 2004

Related U.S. Application Data
(63) Continuation-in-part of application No. 10/609,422, filed on Jul. 1, 2003.

(30) Foreign Application Priority Data
Jul. 2, 2002 (KR) 2002-38051

(51) Int. Cl. G03G 15/06

(52) U.S. Cl. 399/55

(57) ABSTRACT

An image forming apparatus including a photoconductive medium, a laser scanning unit to scan a laser beam to the photoconductive medium to form an electrostatic latent image, and a plurality of developing apparatuses each including a developing roller to adhere toner to the electrostatic latent image, and a supplying roller to supply the toner. The apparatus further includes a transferring unit to transfer a toner image formed on the photoconductive medium to a paper, a voltage supplying apparatus to supply a bias voltage to the developing rollers and the supplying rollers of the respective developing apparatuses to enable the developing apparatus to perform the developing operation, and a controlling apparatus to control the voltage supplying apparatus such that the developing apparatuses perform the developing operations one by one with respect to the respective electrostatic latent images which are formed on the photoconductive medium.

### CROSS-REFERENCE TO RELATED APPLICATIONS

This application claims the benefit of Korean Application No. 2002-38051, filed Jul. 2, 2002, in the Korean Intellectual Property Office, the disclosure of which is incorporated herein by reference.

### BACKGROUND OF THE INVENTION

1. Field of the Invention

The present invention relates to an image forming apparatus, and more particularly, to an image forming apparatus and a method of controlling a developing unit thereof, which develops an electrostatic latent image formed on a photoconductive medium.

2. Description of the Related Art

Generally, an electrophotographic image forming apparatus such as a laser printer, a copier, or a facsimile machine obtains a desired image by adhering toner onto an electrostatic latent image formed on a photoconductive medium, developing the electrostatic latent image, and transferring the developed toner image to a printing paper.

FIG. 1 illustrates a general conventional image forming apparatus including a laser scanning unit (LSU) 10 which generates a laser beam, a photoconductive medium 20 on which an electrostatic latent image is formed by the generated laser beam and an electrifying apparatus 30 which electrifies a surface of the photoconductive medium 20 to a predetermined electric potential. The conventional image forming apparatus also includes a developing unit 40 which forms a toner image by adhering a toner onto an electrostatic latent image of the photoconductive medium 20, a transferring unit 50 which transfers the toner image formed on the photoconductive medium 20 to a paper P, a fusing unit 60 which fuses the transferred toner image on the paper P, and a paper supplying unit 70 which supplies the paper P.

The developing unit 40 includes four developing apparatuses 42, 43, 44, 45 supplying color toner of yellow, magenta, cyan and black, respectively. The developing apparatuses 42, 43, 44, 45 each include a toner receptacle 46 to store the color toner, a developing roller 47 to adhere the color toner stored in the toner receptacle 46 onto the electrostatic latent image of the photoconductive medium 20, and a gap ring 48 to maintain a predetermined gap between the developing roller 47 and the photoconductive medium 20. The developing apparatuses 42, 43, 44, 45 are disposed on a circular turret 41 at a predetermined interval, and are moved toward the photoconductive medium 20 by rotation of the turret 41.

The transferring unit 50 includes a transfer belt 51 to transfer the toner image formed on the photoconductive medium 20 to the paper P, a first transfer roller 52 to transfer the toner image to the transfer belt 51, and a second transfer roller 53 to transfer the toner image which is transferred to the first transfer belt 51 to the paper P.

In the conventional image forming apparatus, when the LSU 10 scans a laser beam to the photoconductive medium 20 electrified by the electrifying apparatus 30, the electrostatic latent image is formed as the electric potential becomes low where the laser beam is scanned. If the yellow developing apparatus 42 approaches the photoconductive medium 20 as the turret 41 rotates, a gap is formed between the developing roller 47 and the photoconductive medium 20 by a contact of the gap ring 48 with a surface of the photoconductive medium 20. At this time, the yellow toner in the toner receptacle 46 is adhered to the electrostatic latent image formed on the photoconductive medium 20 by the developing roller 47. The yellow toner image formed on the photoconductive medium 20 is transferred from between the photoconductive medium 20 and the first transfer roller 52 to the transfer belt 51.

The above developing and transferring processes are repeated with respect to the remaining three developing apparatuses 43, 44, 45. As a result, on the transfer belt 51 is formed a color image which is an overlap of the four colors. The color image is transferred from the transfer belt 51 to the paper P by the second transfer roller 53. The color image adhered to the paper P in a powder state is fused on the paper P by the fusing unit 60.

However, the conventional image forming apparatus generates noise due to collision of the gap ring 48 of the developing unit 40 with the surface of the photoconductive medium 20 when the four developing apparatuses 42, 43, 44, 45 of the developing unit 40 approach the photoconductive medium 20 by the rotation of the turret 41. Additionally, due to the collision of the photoconductive medium 20 and the gap ring 48, the powdery toner image on the photoconductive medium 20 can be scattered and causes the deterioration of the printing quality.

### SUMMARY OF THE INVENTION

Accordingly, it is an aspect of the present invention to solve at least the above problems and/or disadvantages and to provide at least the advantages described below.

It is another aspect of the present invention to provide an image forming apparatus and control method thereof capable of implementing a high-quality image since a plurality of developing apparatuses are fixed at proper positions around a photoconductive medium when developing images to prevent a collision of the developing apparatus with the photoconductive medium.

Additional aspects and advantages of the invention will be set forth in part in the description which follows and, in part, will be obvious from the description, or may be learned by practice of the invention.

The foregoing and/or other aspects are achieved by providing an image forming apparatus including a photoconductive medium, a laser scanning unit to scan a laser beam to the photoconductive medium to form an electrostatic latent image thereon, a plurality of developing apparatuses each including a developing roller to adhere a toner to the electrostatic latent image, a supplying roller to supply the toner, and a toner supply part formed between the developing roller and the supplying roller to supply the toner to the supply roller, a transferring unit to transfer a toner image formed on the photoconductive medium to a paper, a voltage supplying apparatus to supply a bias voltage to the developing rollers and the supplying rollers of the respective developing apparatus to enable the developing apparatus to perform a developing operation, and a controlling apparatus to control the voltage supplying apparatus such that the developing apparatuses perform the developing operation one by one with respect to the respective electrostatic latent images which are formed on the photoconductive medium.

The controlling apparatus applies a reverse bias voltage to the supplying roller of the developing apparatus which has finished the respective developing operation such that the toner on the respective developing roller is collected by the respective supplying roller.

The photoconductive medium includes an image area wherein the electrostatic latent image is formed, and a non-image area where the electrostatic latent image is not formed, a developing area is formed between the photoconductive medium and the respective developing rollers, so that the toner of the developing rollers is moved to the photoconductive medium along the developing area, and the controlling apparatus applies the reverse bias voltage to the supplying roller from when the non-image area is opposite the developing area until when the image area is opposite the developing area.

The controlling apparatus applies a neutral bias voltage to the respective supplying roller, the neutral bias voltage having a same magnitude as the respective bias voltage applied to the developing roller, from when a distance between the non-image area to the developing area and a distance between the respective toner supply part to the developing area are equal until when the non-image area is opposite the developing area.

The respective developing apparatuses each have a gap ring rotating in contact with the photoconductive medium to maintain a predetermined gap between the respective developing rollers and the photoconductive medium.

A controlling method of a developing unit, according to the present invention, including a photoconductive medium, first to fourth developing apparatuses each including a developing roller mounted near the photoconductive medium to adhere toner to an electrostatic latent image formed on the photoconductive medium, a toner supply part, and a supplying roller to supply the toner to the respective developing roller through the toner supply part, the toner supply part being formed between the developing roller and the supplying roller, the controlling method including adhering the toner of the first developing apparatus to the electrostatic latent image of the photoconductive medium, including applying a first bias voltage to cause a potential difference between the first developing roller and the first supplying roller of the first developing apparatus, collecting the toner of the first developing roller including applying a first reverse bias voltage to the first supplying roller, adhering the toner of the second developing apparatus to the electrostatic latent image of the photoconductive medium by applying a second bias voltage to cause a potential difference between the second developing roller and the second supplying roller of the second developing apparatus, collecting the toner of the second developing roller including applying a second reverse bias voltage to the second supplying roller, adhering the toner of the third developing apparatus to the electrostatic latent image of the photoconductive medium, including applying a third bias voltage to cause a potential difference between the third developing roller and the third supplying roller of the third developing apparatus, collecting the toner of the third developing roller including applying a third reverse bias voltage to the third supplying roller, adhering the toner of the fourth developing apparatus to the electrostatic latent image of the photoconductive medium, including applying a fourth bias voltage to cause a potential difference between the fourth developing roller and the fourth supplying roller of the fourth developing apparatus, and collecting the toner of the fourth developing roller including applying a fourth reverse bias voltage to the fourth supplying roller.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 schematically shows the structure of a conventional image forming apparatus;

FIG. 2 schematically shows the structure of an image forming apparatus according to a first embodiment of the present invention;

FIGS. 3A and 3B show the structure and operation of a developing unit of the image forming apparatus of FIG. 2;

FIGS. 4A to 4F show the operation of the image forming apparatus of FIG. 2; and

FIGS. 5A-5D show a bias voltage application control process with respect to the developing unit of FIGS. 3A and 3B.

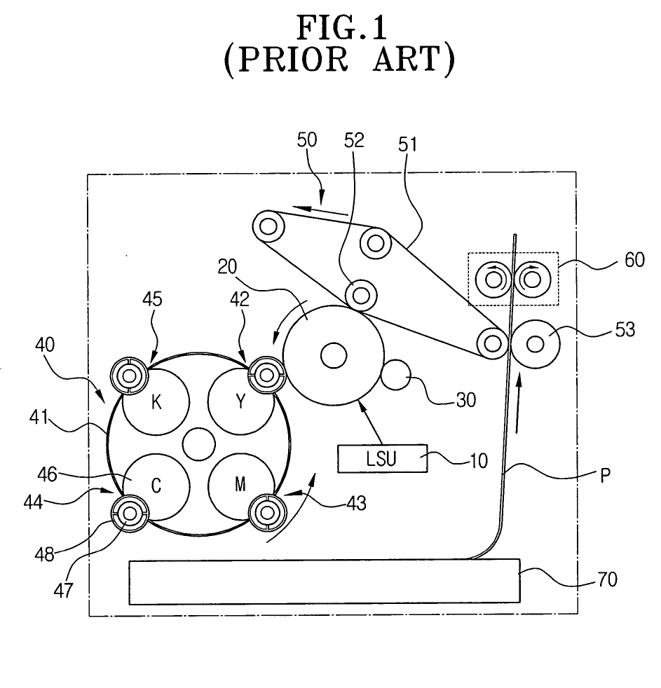

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

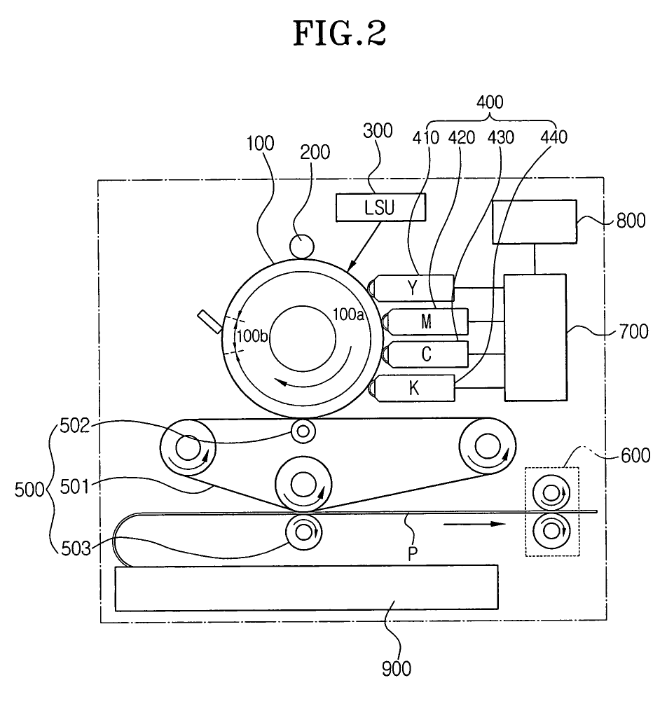

As shown in FIG. 2, the image forming apparatus according to an embodiment of the present invention includes a drum-shaped photoconductive medium 100 having an image area 100a in which an electrostatic latent image is formed, and a non-image area 100b in which an electrostatic latent image is not formed, and an electrifying apparatus 200 to electrify the photoconductive medium 100 to a predetermined electric potential. The image forming apparatus further includes a laser scanning unit 300 to scan a laser beam to the image area 100a of the photoconductive medium 100 to form an electrostatic latent image, a developing unit 400 to adhere a toner onto the electrostatic latent image, and a transferring unit 500 to transfer a toner image formed on the photoconductive medium 100 to a paper P. The image forming apparatus further includes a fusing unit 600 to fuse onto the paper P the powdery toner image which is transferred to the paper P by heat and pressure, a voltage supplying apparatus 700 to apply a bias voltage to the developing unit 400, a controlling apparatus 800 to control the operation of the voltage supplying apparatus 700, and a paper cassette 900 to supply the paper P.

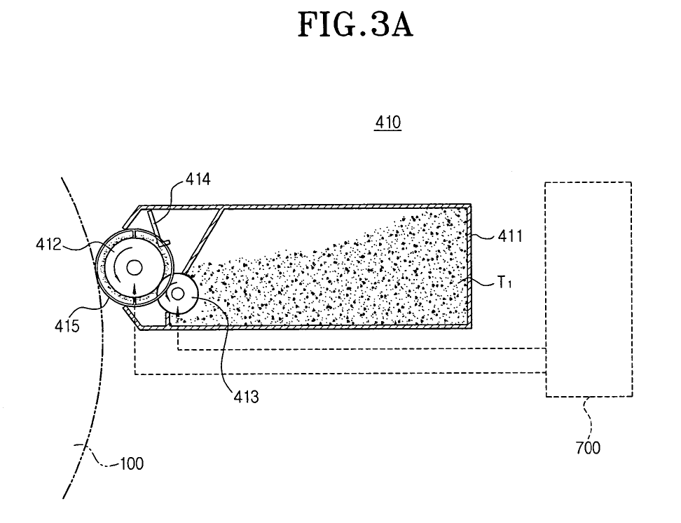

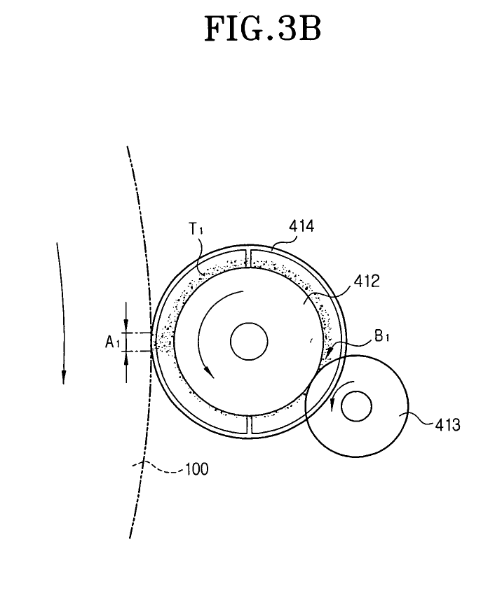

The developing unit 400 includes first to fourth developing apparatuses 410, 420, 430, 440 respectively containing different colors of toner, for example, yellow, magenta, cyan and black. The toner colors of the developing apparatuses 410, 420, 430, 440 are not limited to these colors. FIG. 3A schematically shows the structure of the first developing apparatus 410. As shown in FIG. 3A, the first developing apparatus 410 includes a first toner receptacle 411, a first developing roller 412, a first supplying roller 413, a doctor blade 414, and a gap ring 415. The first toner receptacle 411 stores a yellow toner T₁, and the first developing roller 412 is partially protruded to the outside of the first toner receptacle 411 to adhere the yellow toner T₁ on the photoconductive medium 100. The first supplying roller 413 rotates in contact with the first developing roller 412 to adhere the yellow toner T₁ on the surface of the first developing roller 412. The doctor blade 414 controls the thickness of the yellow toner T₁ adhered onto the first developing roller 412 to a proper extent. The gap ring 415 rotates together with the first developing roller 412, in contact with an outer circumference of the first developing roller 412. The gap ring 415 rotates with its outer circumference in contact with the photoconductive medium 100 so that a constant gap can be maintained between the first developing roller 412 and the photoconductive medium 100. The first developing roller 412 and the first supplying roller 413 are applied with the bias voltage from the voltage supplying apparatus 700. During the developing operation of the first developing apparatus 410, the first developing roller 412 is applied with the bias voltage such as −300V, and the first supplying roller 413 is applied with a positive bias voltage such as −500V. In addition, as shown in FIG. 3B, a first toner supply part B₁ is formed between the first developing roller 412 and the first supplying roller 413, to adhere the toner onto the first developing roller 412. A first developing area A₁ is formed between the photoconductive medium 100 and the first developing roller 412, through which the toner of the first developing roller 412 is transferred to the photoconductive medium 100. When the image area 100a of the photoconductive medium 100 is passed through the first developing area A₁, the yellow toner T₁ on the first developing roller 412 is adhered onto the electrostatic latent image, and accordingly, a toner image is formed.

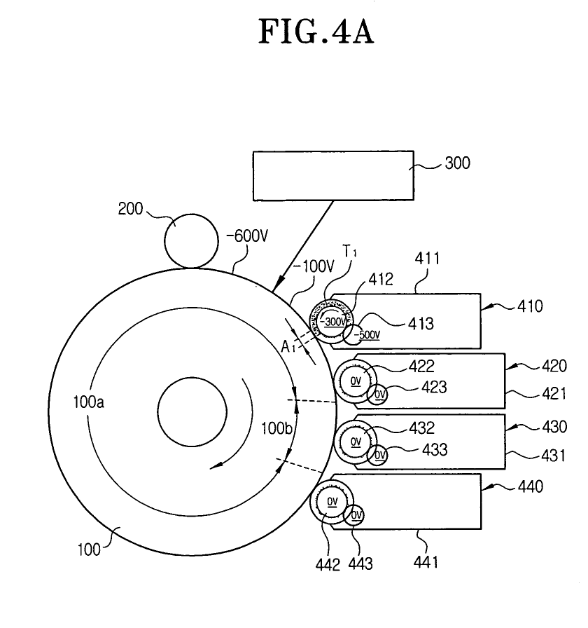

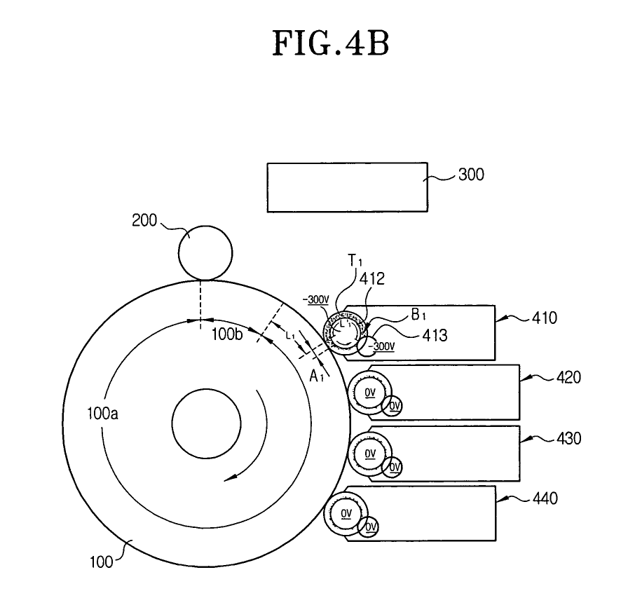

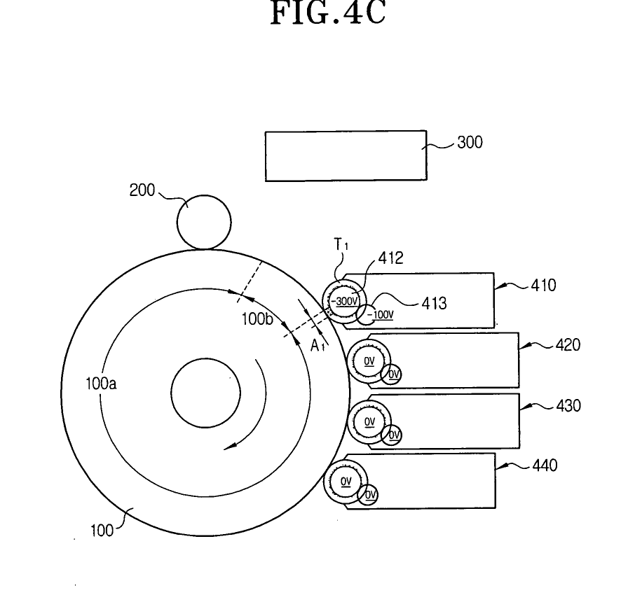

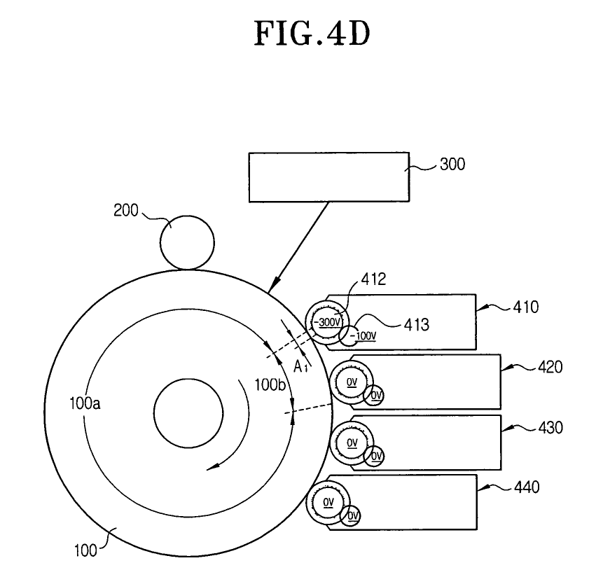

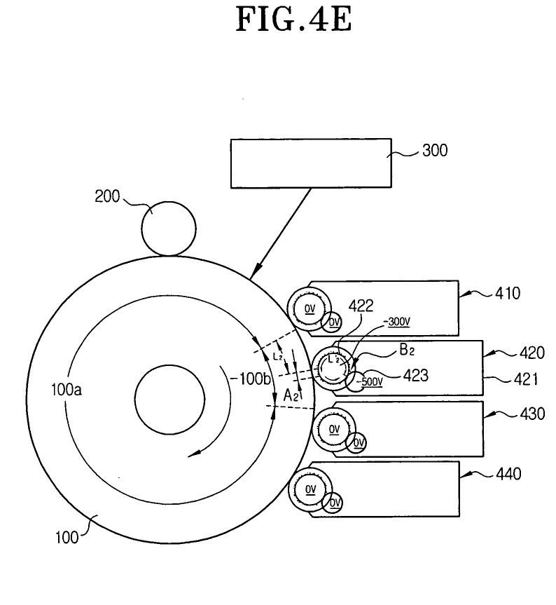

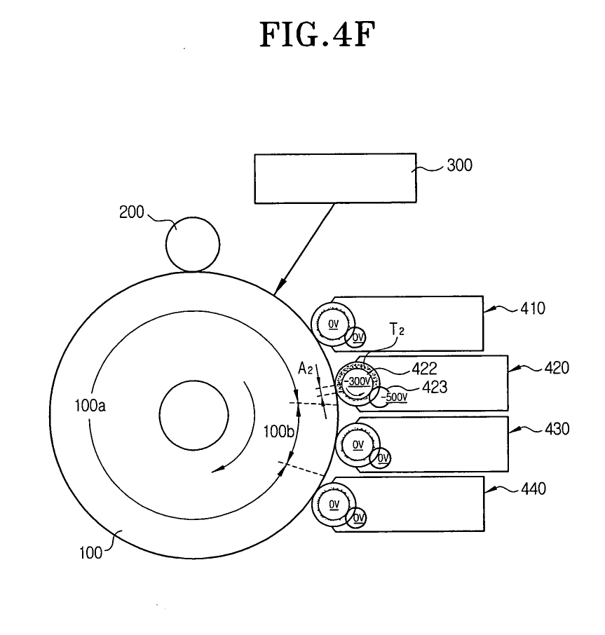

The other three developing apparatuses 420, 430, 440 of the developing unit 400, as shown in FIG. 4A, each includes a toner receptacle 421, 431, 441, a developing roller 422, 432, 442, and a supplying roller 423, 433, 443. The structure of the three developing apparatuses 420, 430, 440 is the same as the first developing apparatus 410, and therefore a detailed description will be omitted.

The transferring unit 500 includes a transfer belt 501, a first transfer roller 502, and a second transfer roller 503. The transfer belt 501 receives a plurality of toner images of different colors from the photoconductive medium 100 in sequential order so that the transferred toner images are overlapped to form a color image. The first transfer roller 502 transfers the toner images formed on the photoconductive medium 100 to the transfer belt 501 one by one. The second transfer roller 503 transfers the color image formed on the transfer belt 501 to the paper P.

The voltage supplying apparatus 700 applies the bias voltage to the respective developing rollers 412, 422, 432, 442 and the respective supplying rollers 413, 423, 433, 443 for the developing operation of the first to the fourth developing apparatuses 410, 420, 430, 440.

The controlling apparatus 800 controls the voltage supplying apparatus 700 such that the plurality of developing apparatuses 410, 420, 430, 440 perform the developing operation in a sequential order. In other words, when the electrostatic latent image is formed on the photoconductive medium 100, the controlling apparatus 800 applies the bias voltage to the developing roller and the supplying roller of one of the developing apparatuses. When the developing apparatus completes developing, the controlling apparatus 800 applies a reverse bias voltage to the corresponding supplying roller for a predetermined time.

Hereinafter, the operation of the image forming apparatus and a controlling method for a developing unit thereof according to the embodiment of the present invention will be described with reference to the accompanying drawings.

When the image forming operation begins, as shown in FIG. 4A, the image area 100a of the photoconductive medium 100 is electrified to a predetermined electric potential such as −600V, by the electrifying apparatus 200. The laser scanning unit 300 scans the laser beam to the electrified image area 100a, and the electric potential of the image area 100a which is scanned by the laser beam lowers to a predetermined laser scanning potential (such as −100V), and therefore, a first electrostatic latent image is formed for a color image. Meanwhile, the controlling apparatus 800 (FIG. 2) controls the voltage supplying apparatus 700 (FIG. 2) so that the first developing apparatus 410 performs the developing operation, and therefore, the first supplying roller 413 receives a positive bias voltage (such as −500V), and the first developing roller 412 receives a bias voltage (such as −300V). The remaining three developing apparatuses 420, 430, 440 are not supplied with the voltage, and the yellow toner T₁ stored in the first toner receptacle 411 is adhered onto the surface of the first developing roller 412 by the first supplying roller 413. As a result, a toner layer is formed on the surface of the first developing roller 412. When the electrostatic latent image of the photoconductive medium 100 approaches the first developing area A₁, which is defined between the first developing roller 412 and the photoconductive medium 100, the yellow toner T₁ of the first developing roller 412 is adhered to the electrostatic latent image which has the potential lower than the first developing roller 412, and accordingly, the toner image is formed.

The positive bias voltage is applied with respect to the first supplying roller 413, as shown in FIG. 4B, before a length of a section L₁ becomes the same as the length of a second section L₁′. The section L₁ is measured from the non-image area 100b of the photoconductive medium 100 to the first developing area A₁, and the second section L₁′ is measured from the first toner supply part B₁ to the first developing area A₁. As shown in FIG. 4B, when the sections L₁ and L₁′ have the same length, a neutral bias voltage (such as −300V), which is the same as the bias voltage applied to the first developing roller 412, is applied to the first supplying roller 413. At this moment, the yellow toner T₁ is not adhered onto the first developing roller 412 any longer, and the yellow toner T₁ which is already adhered to the section L₁′, is adhered to the section L₁ of the image area 100a.

As shown in FIG. 4C, when the non-image area 100b arrives at the first developing area A₁, the reverse bias voltage (such as −100V) is applied to the first supplying roller 413. Since the electric potential of the first developing roller 412 is −300V, the yellow toner T₁ remaining on the surface of the first developing roller 412 is drawn toward the first supplying roller 413, which has the lower electric potential. The application of the reverse bias voltage to the first supplying roller 413 is continued until the image area 100a arrives at the first developing area A₁ again as the photoconductive medium 100 rotates, as shown in FIG. 4D. Thus, most of the yellow toner T₁ adhered onto the first developing roller 412 is collected to the first supplying roller 413 for the duration of time when the reverse bias voltage is being applied to the first supplying roller 413.

The yellow toner image, which is formed on the photoconductive medium 100 by the first developing apparatus 410, is transferred to the transfer belt 501 (FIG. 2) by the first transfer roller 502 (FIG. 2), and the image area 100a of the photoconductive medium 100 is re-electrified to −600V by the electrifying apparatus 200 (FIG. 2), for a new electrostatic latent image to be formed.

When the image area 100a of the photoconductive medium 100 is re-electrified, a second electrostatic latent image is formed on the image area 100a by the laser beam scanned from the laser scanning unit 300, and the controlling apparatus 800 (FIG. 2) controls the voltage supplying apparatus 700 (FIG. 2) so that a bias voltage is applied to the second developing apparatus 420. As shown in FIG. 4E, the bias voltage is applied to the second developing roller 422 when a length L₂ becomes the same as a length L₂′. The length L₂ is measured from the image area 100a of the photoconductive medium 100 to a second developing area A₂, and the length L₂′ is measured from a second toner supply part B₂ to a second developing area A₂. That is, as shown in FIG. 4E, when the lengths L₂ and L₂′ become the same, a magenta toner T₂ (FIG. 4F) stored in the second toner receptacle 421 is adhered to the surface of the second developing roller 422 to form a toner layer.

As shown in FIG. 4F, when the image area 100a having the electrostatic latent image is in the second developing area A₂, the magenta toner T₂ moves from the second developing area A₂ to the electrostatic latent image which has lower electric potential. Accordingly, a magenta toner image is formed. The magenta toner image is transferred to the transfer belt 501 (FIG. 2) by the first transfer roller 502 (FIG. 2), and overlapped with the yellow toner image on the transfer belt 501.

In the same manner as the first developing apparatus 410, the second supplying roller 423 is applied with the neutral bias voltage and the reverse bias voltage in order, and then, the voltage supply is stopped.

The above-described developing operation is accomplished in the third and the fourth developing apparatuses 430, 440. After cyan and black toner images are transferred to the transfer belt 501 one by one, one page of color image is formed by the four colors of the toner images being overlapped on the transfer belt 501. The one-page color image is transferred by the second transfer roller 503 (FIG. 2) to the paper P which is supplied from the paper cassette 900 (FIG. 2), and then adhered to the paper P which is passed through the fusing unit 600 (FIG. 2).

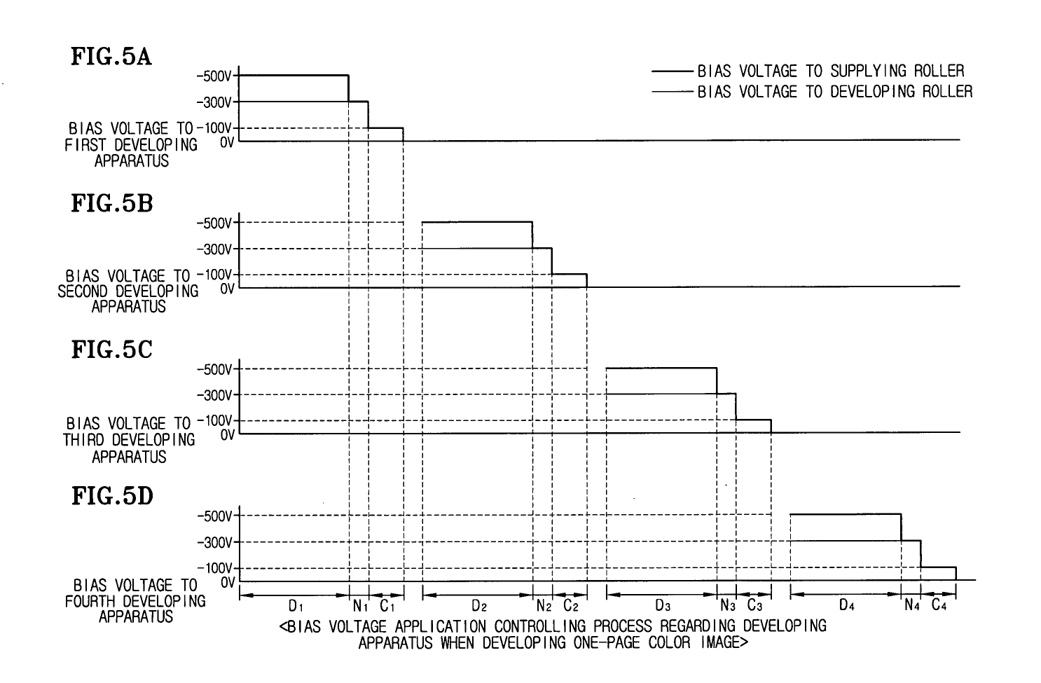

FIGS. 5A-5D show a degree and timing of applying the bias voltage to the respective developing apparatuses 410, 420, 430, 440 by the controlling apparatus 800 to form the one-page color image. In the intervals represented by the letter D, the positive bias voltage is applied to the supplying roller, and therefore, the toner is adhered to the developing roller. In the intervals represented by the letter N, the neutral bias voltage is applied to the respective supplying roller in the same degree as the bias voltage applied to the respective developing roller, and therefore, the toner is not adhered to the respective developing roller. In the intervals represented by the letter C, the reverse bias voltage is applied to the respective supplying roller, and therefore, the toner remaining on the respective developing roller is collected. As shown in FIGS. 5A-5D, when one of the developing apparatuses is applied with the bias voltage for the developing operation, the remaining developing apparatuses are not applied with the bias voltage. Therefore, on the electrostatic latent image formed in order on the photoconductive medium 100 for the one-page color image, only one color of the toner is adhered. In addition, the toner adhered to the developing roller surface of the developing apparatus that has just finished developing, is mostly collected on the supplying roller when the reverse bias voltage is applied to the supplying roller. Therefore, the toner seldom adheres to the electrostatic latent image on the developing roller which is not in operation.

Meanwhile, the degree of the bias voltage applied to the developing apparatus may be variably applied. FIGS. 5A-5D show an example in which the developing interval of a developing apparatus starts a predetermined time after the toner collecting section of the preceding developing apparatus. Many other variations thereof are also possible. For example, the toner collection interval of the developing apparatus and the developing interval of the following developing apparatus may overlap according to positions of the developing apparatus and the extent of the non-image area 100b of the photoconductive medium 100. In another example, the developing interval of the developing apparatus may start immediately after the toner collection section of the preceding developing apparatus.

Further, an example of an image forming apparatus of a non-contact type developing has been described in the above embodiment, in which the developing apparatuses are spaced from the photoconductive medium 100 by a predetermined gap. However, the present invention may also be applied to an image forming apparatus of a contact type developing in which the developing apparatus and the photoconductive medium 100 contact each other with a developing nip formed therebetween.

As described above, since the plurality of developing apparatuses are fixed at proper positions around the photoconductive medium 100, noise or damage of parts can be prevented which are caused by a collision of the developing apparatuses with the photoconductive medium 100.

Additionally, according to the present invention, the toner adhered onto the developing roller is collected to the supplying roller immediately after the developing operation. Accordingly, only the toner of the developing apparatus currently in operation is adhered to the electrostatic latent image on the photoconductive medium 100. As a result, a high-quality color image can be obtained.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus, comprising:
a photoconductive medium;
a laser scanning unit to scan a laser beam to the photoconductive medium to form an electrostatic latent image thereon;
a plurality of developing apparatuses each comprising:
a developing roller to adhere a toner to the electrostatic latent image,
a supplying roller to supply the toner, and
a toner supply part formed between the developing roller and the supplying roller to adhere the toner onto the supplying roller;
a transferring unit to transfer a toner image including the adhered toner formed on the photoconductive medium to a paper;
a voltage supplying apparatus to supply a bias voltage to the developing rollers and the supplying rollers of the respective developing apparatuses to enable the developing apparatuses to perform respective developing operations; and
a controlling apparatus to control the voltage supplying apparatus such that the developing apparatuses perform the developing operations one by one with respect to the respective electrostatic latent images which are formed on the photoconductive medium.

2. The image forming apparatus of claim 1, wherein the controlling apparatus applies a reverse bias voltage to the supplying roller of the developing apparatus which has finished the respective developing operation such that the toner on the respective developing roller is collected by the respective supplying roller.

3. The image forming apparatus of claim 2, wherein:
the photoconductive medium includes:
an image area wherein the electrostatic latent image is formed, and
a non-image area wherein the electrostatic latent image is not formed,
a developing area is formed between the photoconductive medium and the respective developing roller, so that the toner of the respective developing roller is moved to the photoconductive medium along the developing area; and
the controlling apparatus applies the reverse bias voltage to the respective supplying roller from when the non-image area is opposite the developing area until when the image area is opposite the developing area.

4. The image forming apparatus of claim 3, wherein the controlling apparatus applies a neutral bias voltage to the respective supplying roller, the neutral bias voltage having a same magnitude as the respective bias voltage applied to the developing roller, from when a distance between the non-image area to the developing area and a distance between the respective toner supply part to the developing area are equal until when the non-image area is opposite the developing area.

5. The image forming apparatus of claim 2, wherein the controlling apparatus controls the voltage supplying apparatus to stop supplying the bias voltage to the respective supplying roller after the toner of the respective developing roller is collected.

6. The image forming apparatus of claim 2, wherein a magnitude of the reverse bias voltage is less than or equal to an electric potential where the electrostatic latent image is formed.

7. The image forming apparatus of claim 1, wherein the respective developing apparatuses each have a gap ring rotating in contact with the photoconductive medium to maintain a predetermined gap between the respective developing roller and the photoconductive medium.

8. A controlling method of a developing unit comprising a photoconductive medium, first to fourth developing apparatuses each comprising a developing roller mounted near the photoconductive medium to adhere toner to an electrostatic latent image formed on the photoconductive medium, a toner supply part, and a supplying roller to supply the toner to the respective developing roller through the toner supply part, the toner supply part being formed between the developing roller and the supplying roller, the controlling method comprising:
adhering the toner of the first developing apparatus to the electrostatic latent image of the photoconductive medium, comprising applying a first bias voltage to cause a potential difference between the first developing roller and the first supplying roller;
collecting the toner of the first developing roller comprising applying a first reverse bias voltage to the first supplying roller;
adhering the toner of the second developing apparatus to the electrostatic latent image of the photoconductive medium by applying a second bias voltage to cause a potential difference between the second developing roller and the second supplying roller;
collecting the toner of the second developing roller comprising applying a second reverse bias voltage to the second supplying roller;
adhering the toner of the third developing apparatus to the electrostatic latent image of the photoconductive medium, comprising applying a third bias voltage to cause a potential difference between the third developing roller and the third supplying roller;
collecting the toner of the third developing roller comprising applying a third reverse bias voltage to the third supplying roller;
adhering the toner of the fourth developing apparatus to the electrostatic latent image of the photoconductive medium, comprising applying a fourth bias voltage to cause a potential difference between the fourth developing roller and the fourth supplying roller; and
collecting the toner of the fourth developing roller comprising applying a fourth reverse bias voltage to the fourth supplying roller.

9. The controlling method of claim 8, wherein the photoconductive medium includes an image area whereon the electrostatic latent image is formed, and a non-image area whereon the electrostatic latent image is not formed, and a developing area between the photoconductive medium and the respective developing roller, so that the toner of the respective developing roller is moved to the photoconductive medium along the developing area, the method further comprising:
applying the respective reverse bias voltage to the supplying roller from when the non-image area is opposite the developing area until when the image area is opposite the developing area.

10. The controlling method of claim 9, further comprising applying a neutral bias voltage to the supplying roller, the neutral bias voltage having a same magnitude as the bias voltage applied to the respective developing roller, from when a distance from the non-image area to the developing area and a distance from the respective toner supply part to the developing area become equal until when the non-image area is opposite the developing area.

11. The controlling method of claim 8, further comprising discontinuing the respective voltages applied to the developing rollers and supplying rollers, after the collecting of the respective toners.

12. The controlling method of claim 8, wherein a magnitude of the reverse bias voltages is less than, or equal to a potential where the electrostatic latent image is formed.

13. The controlling method of claim 9, wherein the applying of the respective bias voltage begins when a distance from the image area to the developing area and a distance from the respective toner supply part to the developing area are equal.

14. An apparatus comprising:
a photoconductive medium to form electrostatic latent images thereon;
first and second developers, each comprising:
a developing roller to receive color toner and transfer the received color toner to the respective electrostatic latent image,
a supplying roller to supply the toner to the developing roller, and
a toner supply part formed between the developing roller and the supplying roller to adhere the toner onto the developing roller;
a voltage supplier to supply a bias voltage to the developing rollers and the supplying rollers of the respective developers to enable the developers to perform respective developing operations, and
a controller to control the voltage supplier such that the developers perform the developing operations one by one with respect to the respective electrostatic latent images which are formed on the photoconductive medium.

15. The image forming apparatus of claim 14, wherein the controller applies a reverse bias voltage to the supplying roller of the developer which has finished the respective developing operation such that the toner on the respective developing roller is collected by the respective supplying roller.

16. A method comprising:
forming an electrostatic latent image on a photoconductive medium;
applying a voltage to a first developing roller while a second developing roller receives no voltage, to attach a first color developer to the first developing roller and not the second developer;
transferring the attached developer to the electrostatic latent image; and
applying a neutral bias voltage to a supplying roller adjacent to the first developing roller to stop the attaching of the first color developer to the first developing roller.

17. The method of claim 16, wherein the transferring of the attached developer comprises transferring the developer when the electrostatic latent image approaches a developing area of the first developing roller, the developing area being between the first developing roller and the photoconductive medium.

18. The method of claim 17, wherein the photoconductive medium comprises an image area and a non-image area, and the forming of the electrostatic image comprises forming the electrostatic image on the image area.

19. The method of claim 18, further comprising:
applying a supply voltage to the supplying roller to thereby supply the toner to the first developing roller via a toner supply part formed between the supplying roller and the first developing roller, before a length of a first section becomes the same as a length of a second section, the first section extending from the non-image area of the photoconductive medium to the developing area, and the second section extending from the toner supply part to the developing area.

20. The apparatus of claim 2, wherein the toner is collected during the developing operation of the next developing apparatus.

21. The apparatus of claim 2, wherein the developing operation of the next developing apparatus begins immediately after the toner is collected.

22. An apparatus comprising:
a photoconductive medium to form electrostatic latent images thereon;
first and second developers, each comprising:
a developing roller to receive color toner and transfer the received color toner to the respective electrostatic latent image,
a supplying roller to supply the toner to the developing roller, and
a toner supply part formed between the developing roller and the supplying roller to adhere the toner onto the developing roller; and
a voltage supplier to sequentially supply a bias voltage to the developing roller and the respective supplying roller performing a developing operation, the developer not performing the developing operation not receiving the bias voltage.
